(19) United States
(12) Patent Application Publication
(10) Pub. No.: US 2024/0075532 A1
(43) Pub. Date: Mar. 7, 2024

(54) METAL POWDER RECYCLING SYSTEM

(71) Applicant: TUSAS- TURK HAVACILIK VE UZAY SANAYII ANONIM SIRKETI, Ankara (TR)

(72) Inventors: Sertac ALTINOK, Ankara (TR); Hakan YAVAS, Ankara (TR); Ahmet Alptug TANRIKULU, Ankara (TR)

(21) Appl. No.: 18/268,285

(22) PCT Filed: May 24, 2021
(86) PCT No.: PCT/TR2021/050476

§ 371 Date: Jun. 19, 2023

(30) Foreign Application Priority Data
Dec. 29, 2020 (TR) 2020/22262

(51) Int. Cl. B22F 12/86; B22F 9/02; B22F 9/04; B22F 12/90; B33Y 30/00; B33Y 40/10; B33Y 50/02

(52) U.S. Cl. CPC B22F 12/86; B22F 9/023; B22F 9/04; B22F 12/90; B33Y 30/00; B33Y 40/10; B33Y 50/02; B22F 2009/001

(57) ABSTRACT

A metal power recycling system has at least one chamber into which metal scraps are placed, at least one transmission line enabling metal scraps to be transferred out of the chamber, at least one pretreatment unit into which the metal scraps are transferred through the transmission line and in which oxygen removal, hydrogenation, cooling, grinding and sieving processes are performed for the metal scraps, at least one gathering chamber into which the sieved powder-form metal scraps are transferred from the pretreatment unit through the transmission line is disclosed.

This invention relates to a recycling system that enables the recovery and reproduction of scrap materials in a usable form, which are obtained from metallic workpieces used in engineering applications.

The production of high strength metal alloy materials from ores as preferred for use in harsh environmental conditions, as well as the material processing methods for bringing the materials into forms suitable for use in engineering applications after production are difficult and costly. Scrap materials in the form of chips formed during the production and processing processes of metal alloys can be integrated into recycling systems and reproduced according to the area where they will be used.

The patent document U.S. Ser. No. 10/639,712B2, which is included in the known state of the art, describes that powder is produced from scrap materials with a titanium main component for use in additive manufacturing processes by means of a recycling system. Mentioned patent document describes that scraps are subjected to drying, purifying, hydration, grinding, dehydration, sieving and to a microwave plasma process for spheroidizing powder particles under the recycling system.

Thanks to the metal powder recycling system developed by the present invention, metal alloys in the form of chips will be recycled more efficiently and practically from scrap and will be more suitable for industrial production.

Another object of the present invention is to realize a continuous transfer of powder from the initial to the final phase of the process, which is designed to enable the production of metal alloy in the metal powder recycling system from user-predetermined low amounts to higher amounts in accordance with the process.

The metal powder recycling system realized to achieve the object of the invention, as defined in the first claim and in the claims dependent thereon, comprises at least one chamber containing wet-cleaned and dried metal scrap, at least one transmission line allowing the metal scraps in the chamber to be transferred out of the chamber, at least one pretreatment unit to which metal scraps are transferred using the transmission line and in which oxygen removal, hydration, cooling, grinding and sieving processes are applied to metal scraps, at least one gathering chamber to which the metal scraps in powder form are transferred using the transmission line after a screening process applied in the pretreatment unit.

The metal powder recycling system of the invention comprises at least one sensor positioned on the transmission line allowing the metal scraps to be transferred to different processes in the pretreatment unit; at least one control unit controlling the supply of metal scraps present in the pretreatment unit according to the data sent by the sensors on the transmission line so as to enable the metal scraps to be supplied and transferred simultaneously and continuously after the first metal scraps are transferred in the transmission line allowing the metal scraps to be transferred between the pretreatment unit and the chamber, and in the transmission line allowing the metal scraps to be transferred between the pretreatment unit and the gathering chamber.

In an embodiment of the invention, the metal powder recycling system comprises at least one dehydration chamber to which the metal scraps are transferred using the transmission line for performing a hydrogen removal process from the structure of metal scraps transferred to the gathering chamber, and at least one additive manufacturing device to which the metal scraps in a dehydrided powder form are transmitted using the transmission line for use in a manufacturing process. It comprises at least one control unit controlling the supply of metal scraps in the pretreatment unit according to the data sent by the sensors on the transmission line so as to enable the metal scraps to be supplied and transferred simultaneously and continuously after the first metal scraps are transferred in the transmission line allowing the metal scraps to be transferred between the pretreatment unit and the gathering chamber, and in the transmission line allowing the metal scraps to be transferred between the dehydration chamber and the additive manufacturing device.

In an embodiment of the invention, the metal powder recycling system comprises multiple transmission lines enabling the transfer of metal scraps from the pretreatment unit for the processes up to the transferring to the additive manufacturing device, and multiple valves that are controlled to be opened or closed according to the data transferred to the control unit by the sensors, so as to enable the metal scraps to be supplied and transferred simultaneously and continuously after the first metal scraps are transferred in the transmission line making transmission out of the chamber and in the transmission line in which the metal scraps are transferred to be supplied to the additive manufacturing device.

In an embodiment of the invention, the metal powder recycling system comprises at least one vacuum unit in the pretreatment unit, into which metal scraps are transferred from the chamber and in which an oxygen removal process is applied to the transferred metal scraps; at least one vacuum unit outlet valve enabling the metal scraps to be transferred to the transmission line to be transferred to the next operation by opening according to the data transmitted by the sensors to the control unit after the oxygen removal process is performed on the metal scraps in the vacuum unit; at least one hydration chamber into which the metal scraps are transferred from the vacuum unit outlet valve and in which the hydrogenation of the metal scraps is enabled; at least one hydration chamber outlet valve enabling the metal scraps to be transferred to the transmission line to be transferred to the next operation by opening according to the data transmitted by the sensors to the control unit after the hydration process is completed; at least one cooling chamber into which metal scraps are transferred from the hydration chamber outlet valve and in which a cooling process is applied to the metal scraps; at least one cooling chamber outlet valve enabling the metal scraps to be transferred to the transmission line to be transferred to the next operation by opening according to the data transmitted by the sensors to the control unit after the metal scraps are cooled in the cooling chamber; at least one mill into which the metal scraps are transferred from the cooling chamber outlet valve for reducing them to user-predetermined sizes and in which a grinding process is performed; at least one mill outlet valve enabling the metal scraps to be transferred to the transmission line to be transferred to the next operation by opening according to the data transmitted by the sensors to the control unit after the grinding process applied to the metal scraps is completed; at least one sieve enabling metal scraps of different sizes transferred from the mill outlet valve to be sieved; at least one sieve outlet valve enabling the metal scraps to be transferred to the transmission line to be transferred to the next operation by opening according to the data transmitted by the sensors to the control unit after the metal scraps are obtained at certain sizes following the sieving process.

In an embodiment of the invention, the metal powder recycling system comprises at least one scrap chamber in which metal scraps are kept before being transferred to the chamber, a first chamber and/or a second chamber to which the metal scraps in the scrap chamber are transferred using the transmission line, a first chamber inlet valve and a first chamber outlet valve provided in the first chamber, enabling the metal scrap to be transferred into the first chamber and the metal scrap to be transferred out of the first chamber respectively, a second chamber inlet valve and a second chamber outlet valve provided in the second chamber, enabling the metal scrap to be transferred into the second chamber and the metal scrap to be transferred out of the second chamber respectively, and a control unit closing the first chamber inlet valve that enables the metal scrap to be supplied to the first chamber according to the data transmitted by the sensors after the first chamber is almost entirely filled by metal scraps, and at the same time, opening the second chamber inlet valve and the first chamber outlet valve to allow metal scraps to be transferred to the second chamber and thus enables to continuously transfer metal scraps into the pretreatment unit.

In an embodiment of the invention, the metal powder recycling system comprises a first gathering chamber and a second gathering chamber, enabling sieved metal scraps to be collected therein, a first gathering chamber inlet valve provided on the first gathering chamber, enabling the metal scraps to be transferred to the first gathering chamber and controlled by the control unit according to the data transmitted from the sensors, a second gathering chamber inlet valve provided on the second gathering chamber, enabling the metal scraps to be transferred to the second gathering chamber and controlled by the control unit according to the data transmitted from the sensors, and the control unit that closes the first gathering chamber inlet valve according to the data transmitted from the sensors after the first gathering chamber is almost entirely filled with metal scraps, and at the same time, that enables to open the second gathering chamber inlet valve and the first gathering chamber outlet valve so as to allow the metal scraps to be transferred into the second gathering chamber and thereby to enable the metal scraps in a powder form to be continuously transferred into the additive manufacturing device.

In an embodiment of the invention, the metal powder recycling system comprises a first vacuum unit into which metal scraps are transferred through the transmission line from the first chamber after the first chamber is almost completely filled, a first hydration chamber to which the metal scraps are transferred through the transmission line after the first vacuum unit, a second vacuum unit into which metal scraps are transferred through the transmission line after the second chamber is almost completely filled, a second hydration chamber to which the metal scraps are transferred through the transmission line after the second vacuum unit, a first sensor provided in the first vacuum unit and in the second vacuum unit and gathering data about the filling and failure state of the first vacuum unit and of the second vacuum unit, a second sensor provided in the first hydration chamber and in the second hydration reservoir and gathering data about the filling and failure state of the first hydration reservoir and of the second hydration reservoir, and the control unit that controls and directs the transfer of metal scraps from the scrap chamber to the first chamber and second chamber according to the filling and failure data transmitted from the sensors so that a continuous supply is provided to the gathering chamber.

In an embodiment of the invention, the metal powder recycling system comprises a mill consisting of at least two mutually positioned grinders, each of which being able to rotate about its axis in a direction that is opposite to the other's rotation direction and each of which being of a different size from the other.

In an embodiment of the invention, the metal powder recycling system comprises at least one residue chamber into which the metal scraps which are not of a user-determined size and could not be sieved are transferred through a sieve by means of the transmission line and then the metal scraps therein are transferred back to the grinder.

In an embodiment of the invention, the metal powder recycling system comprises a cooling chamber having an outer wall over which a cooling fluid is passed from the first outlet port that is in connection with the mill to the second outlet port that is in connection with the hydration chambers, thereby the formation of agglomeration in the cooling chamber being prevented.

In an embodiment of the invention, the metal powder recycling system comprises a sieve, enabling the separation of metal scraps of a user-predetermined size using a vibration band provided thereon.

In an embodiment of the invention, the metal powder recycling system comprises at least one motor that can be activated by a signal transmitted from the control unit, and a transmission line that can be actuated using the motor.

In an embodiment of the invention, the metal powder recycling system comprises a vacuum unit that is rotatable around itself or from a point other than its axis of symmetry, and thereby provides a more efficient vacuum medium.

In an embodiment of the invention, the metal powder recycling system comprises metal scraps made of titanium alloy.

The metal powder recycling system realized to achieve the object of the present invention is shown in the attached figures, wherein from these figures;

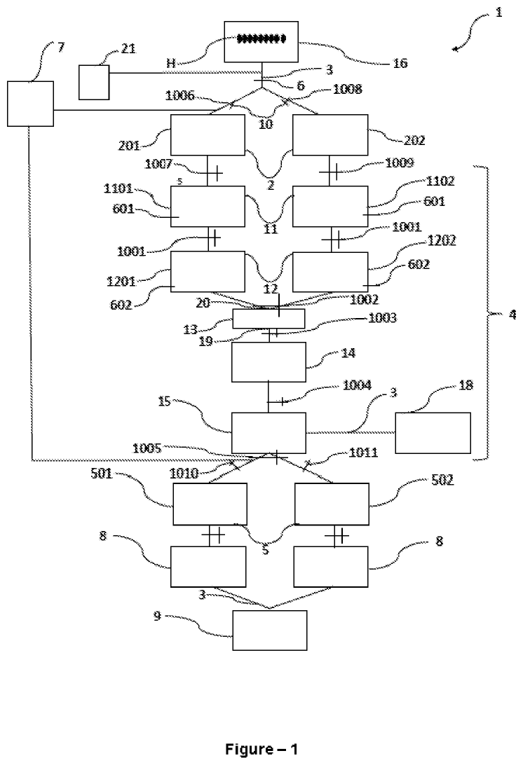

FIG. 1 is a flow chart of the metal powder recycling system.

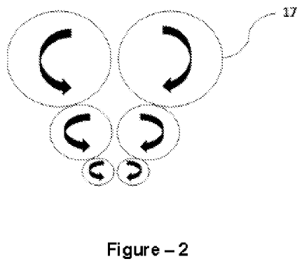

FIG. 2 is a schematic view of the grinder grinders.

The parts illustrated in figures are individually assigned a reference number and the corresponding terms of this number are listed below.
H: Metal scrap
1. Metal powder recycling system
2. Chamber
201. First chamber
202. Second chamber
3. Transmission line
4. Pretreatment unit
5. Gathering chamber
501. First gathering chamber
502. Second gathering chamber
6. Sensor
601. First sensor
602. Second sensor
7. Control unit
8. Dehydration chamber
9. Additive manufacturing device
10. Valve
1001. Vacuum unit outlet valve
1002. Hydration chamber outlet valve
1003. Cooling chamber outlet valve
1004. Grinder outlet valve
1005. Sieve outlet valve
1006. First chamber inlet valve
1007: First chamber outlet valve
1008: Second chamber inlet valve
1009: Second chamber outlet valve
1010: First gathering chamber inlet valve
1011: Second gathering chamber inlet valve
11. Vacuum unit
1101. First vacuum unit
1102: Second vacuum unit
12. Hydration chamber
1201. First hydration chamber
1202. Second hydration chamber
13. Cooling chamber
14. Mill
15. Sieve
16. Scrap chamber
17. Grinder
18. Residue chamber
19. First outlet port
20. Second outlet port
21. Motor

The metal powder recycling system (1) comprises at least one chamber (2) into which metal scraps (H) are put, at least one transmission line (3) enabling metal scraps (H) to be transferred out of the chamber (2), at least one pretreatment unit (4) into which the metal scraps (H) are transferred through the transmission line (3) and in which oxygen removal, hydration, cooling, grinding and sieving processes are performed for the metal scraps (H), at least one gathering chamber (5) into which the sieved powder-form metal scraps (H) are transferred from the pretreatment unit (4) through the transmission line (3) (FIG. 1).

The metal powder recycling system (1) of the invention comprises at least one sensor (6) provided on the transmission line (3) in the pretreatment unit (4), and at least one control unit (7) controlling the supply of the metal scraps (H) in the pretreatment unit (4) according to the data transmitted from the sensors (6) so as to ensure a simultaneous and continuous flow of metal scraps (H) after the first metal scraps (H) are transferred in the transmission line (3) between the pretreatment unit (4) and the chamber (2) and in the transmission line (3) between the pretreatment unit (4) and the gathering chamber (5).

Metal alloys used in engineering applications can be obtained by recycling metal scrap (H) in powder form. Metal scraps (H) of different sizes, which are washed and dried-cleaned are first loaded into one or more chambers (2) to be fed to the metal powder recycling system (1). Metal scraps (H) are transferred to the pretreatment unit (4) through the transmission line (3). The metal scraps (H) are subjected to oxygen removal, hydration, cooling, grinding and sieving processes in the pretreatment unit, respectively. Metal scraps in the form of sieved powder (H) are transferred to the gathering chamber (5) through the transmission line (3).

Between the processes carried out in the pretreatment unit (4) are provided sensors on the transmission line (3) where metal scraps (H) are transferred. The control unit (7) controls the flow of metal scraps (H) in the transmission lines (3) within the pretreatment unit (4) according to the data transmitted from the sensors (6) so as to ensure a simultaneous and continuous supply of metal scrap in the transmission line (3) used for transferring metal scraps (H) from the chamber (2) into the pretreatment unit (4) and in the transmission line (3) used for transferring metal scraps (H) from the pretreatment unit (4) to the gathering chamber (5). After the first metal scraps (H) are transferred to the gathering chamber (5), a supply is made so that a simultaneous and continuous presence of metal scraps (H) is provided in the transmission line (3) between the chamber (2) and the pretreatment unit (4) and in the transmission line (3) between the pretreatment unit (4) and the gathering chamber (5).

In one embodiment of the invention, the metal powder recycling system (1) comprises at least one dehydration chamber (8) into which powder-form metal scraps (H) are transferred from the gathering chamber (5) and in which a dehydration process is performed; at least one additive manufacturing device (9) into which dehydrided powder-form metal scraps (H) are transferred through the transmission line (3) for use in production; at least one control unit (7) controlling the supply of metal scraps (H) in the transmission line (3) according to the data transmitted from the sensors (6) so as to ensure a simultaneous and continuous flow of powder-form metal scraps (H) after the first metal scraps (H) are transferred in the transmission line (3) between the pretreatment unit (4) and the gathering chamber (5) and in the transmission line (3) between the dehydration chamber (8) and the additive manufacturing device (9). Metal scraps (H) in the form of hydrided powder are transferred to the dehydration chamber (8) through the transmission line (3) in order to remove hydrogen form the powder-form metal scrap (H). Powder-form metal scraps (H) are placed under vacuum in the dehydration chamber (8) and kept at high temperature for a certain period of time. As a result this, the hydrogen in the structure of metal scraps (H) will be separated from the structure. Following the process, air or nitrogen gas is fed into the dehydration chamber (8) and thus atmospheric pressure will be created in the dehydration chamber (8). After the completion of the dehydration hydration process in the dehydration chamber (8), powder-form metal scraps (H) are transferred from the dehydration chamber (8) to the additive manufacturing device (9) through the transmission line (3) for use in engineering applications. Powder-form metal scraps (M) to be used in user-designated engineering applications can be transferred directly to the additive manufacturing device after the dehydration process, or in cases where it is required to change the form of the powder, powder-form metal scraps (H) subjected or not subjected to dehydration can be transferred to the additive manufacturing device after a thermal plasma process is applied. According to the data transmitted from the sensors in the system, the control unit ensures a simultaneous and continuous presence of metal scraps (H) in the transmission line (3) between the pretreatment unit (4) and the gathering chamber (5) and in the transmission line (3) between the dehydration chamber (8) and the additive manufacturing device (9).

In one embodiment of the invention, the metal powder recycling system (1) comprises multiple transmission lines (3) between the pretreatment unit (5) and the additive manufacturing device (9); and multiple valves (10) controlled by the control unit (7) according to the data received by the control unit (7) from the sensors (6) so as to assume an open or closed position, thereby allowing a simultaneous and continuous presence of metal scraps (H) in the transmission line (3) in which metal scraps (H) are transferred out of the chamber (2) and in the transmission line (3) transferring metal scraps to the additive manufacturing device (9) after the first metal scraps (H) are transferred to the additive manufacturing device (9). There are multiple transmission lines (3) that allow metal scraps (H) to be transferred between the processes in the recycling system. Valves (10) which can be in an open or closed position under the control of the control unit (7) according to the data transmitted from the sensors (6) in the transmission lines (3) are included in the metal powder recycling system (1). In this way, the continuity of the metal powder recycling system (1) is ensured and a simultaneous and continuous presence of metal scraps (H) is provided in the transmission line (3) allowing metal scraps (H) to be transferred into the chamber (2) and in the transmission line enabling powder-form metal scraps (H) to be transferred to the additive manufacturing device (9).

In an embodiment of the invention, the metal powder recycling system (1) comprises at least one vacuum unit (11) provided in the pretreatment unit (4) and enabling the removal of oxygen present in the structure of the metal scraps (H) transferred therein through the transmission line (3) from the chamber (2); at least one vacuum unit outlet valve (1001) opened by the control unit (7) according to the data transmitted by the sensors (6) after the completion of the oxygen removal process in the vacuum unit (11) and enabling the metal scraps (H) to be transferred to the transmission line (3); at least one hydration chamber (12) into which metal scraps (H) are transferred from the vacuum unit (11) and a hydration process is applied to the metal scraps (H); at least one hydration chamber outlet valve (1002) opened by the control unit (7) according to the data transmitted from the sensors (6) after the completion of the hydration process and enabling the metal scraps (H) to be transferred to the transmission line (3); at least one cooling chamber (13) enabling the cooling of the metal scraps (H) transferred therein from the hydration chamber (12); at least one cooling chamber outlet valve (1003) opened by the control unit (7) according to the data transmitted from the sensors (6) after the completion of the cooling process and enabling the metal scraps (H) to be transferred to the transmission line (3); at least one mill (14) enabling the metal scraps (H) transferred therein from the cooling chamber (13) to be reduced to user-predetermined sizes; at least one mill outlet valve (1004) opened by the control unit (7) according to the data transmitted from the sensors (6) after the completion of the grinding process and enabling the metal scraps (H) to be transferred to the transmission line (3); at least one sieve (15) enabling the sieving of metal scraps (H) to different sizes, said metal scraps (H) being transferred therein from the mill (14); and at least one sieve outlet valve (1005) opened by the control unit (7) according to the data transmitted from the sensors (6) after the completion of the sieving process and enabling the powder-form metal scraps (H) to be transferred to the transmission line (3). Metal scraps (H) are transferred from the chambers (2) to the vacuum units (11) through the transmission line (3). Metal scraps (H) in vacuum units (11) are processed under vacuum to be deoxygenated. After the vacuuming process in the vacuum unit (11), argon gas is fed into the vacuum unit (11). After the vacuum unit (11), the metal scraps (H) are transferred to the hydration chamber (12) through the transmission line (3) by the control unit (7) opening the vacuum unit outlet valve (1001) depending on the data transmitted from the sensors (6). Hydrogen gas is applied to metal scraps (H) in the hydration chamber (12) and metal hydrides are formed as a result of the atoms separating from the surfaces of metal scraps (H) and getting incorporated into the structure. In this way, metal scraps (H) with a more brittle structure are formed. After the control unit (7) opens the hydration chamber outlet valve (1002) according to the data transmitted from the sensors (6), the hydrided metal scraps (H) leaving the hydration chamber (12) at high temperature will be transferred to the cooling chamber (13) through the transmission line (3). After the control unit (7) opens the cooling chamber outlet valve (1003) depending on the data transmitted from the sensors (6), the hydrided metal scraps (H) cooled in the cooling chamber (13) are transferred to the mill (14) to be turned into a powder form. The metal scraps (H) pulverized in the mill (14) are collected on the sieve (15) when the control unit (7) opens the mill outlet valve (1004) depending on the data transmitted from the sensors (6). After the control unit (7) opens the sieve outlet valve (1005) depending on the data transmitted from the sensors (6), the powder-form metal scraps (H) that can pass through the sieve (15) are transferred to the gathering chamber (5) through the transmission line (3).

In an embodiment of the invention, the metal powder recycling system (1) comprises at least one scrap chamber (16) in which the metal scraps (H) are collected, a first chamber (201) and/or a second chamber (202) into which metal scrap (H) is transferred from the scrap chamber (16) through the transmission line (3), a first chamber inlet valve (1006) and a first chamber outlet valve (1007) provided in the first chamber (201), a second chamber inlet valve (1008) and a second chamber outlet valve (1009) provided in the second chamber (202), a control unit (7) that closes the first chamber inlet valve (1006) according to the data it receives from the sensors (6) when the first chamber (201) is almost completely filled and simultaneously opens the second chamber inlet valve (1008) and the first chamber outlet valve (1007) and thus enables the pretreatment unit (4) to be filled continuously with metal scraps (H) so that it is never left empty. Cleaned and dried metal scraps (H) are kept in the scrap chamber (16) before being transferred to the chamber (2). The transfer of metal scrap (H) from scrap chambers (16) to chambers (2) is controlled by the control unit (7). When the first chamber (201) is sufficiently filled, the first chamber (201) will be sensed as filled by the control unit (7) controlling the chambers (2) by means of the sensors (6). After the first chamber (201) is filled, the first chamber inlet valve (1006) will be closed by the control unit (7) and the second chamber inlet valve (1008) will be opened simultaneously and metal scraps (2) will be directed to the second chamber (202) and collected there. In this way, a continuous flow of metal scraps (H) will be provided into the pretreatment unit (4).

In one embodiment of the invention, the metal powder recycling system (1) comprises a first gathering chamber (501) and a second gathering chamber (502) in which sieved metal scraps (H) are collected; a first gathering chamber inlet valve (1010) provided in the first gathering chamber (501) and controlled by the control unit (7); a second gathering chamber inlet valve (1011) provided in the second gathering chamber (502) and controlled by the control unit (7); and a control unit (7) that closes the first gathering chamber inlet valve (1010) according to the data transmitted by the sensors (6) when the first gathering chamber (501) is almost completely filled and opens the second gathering chamber inlet valve (1011), thus enabling the powder-form metal scraps (H) to be transferred to the second gathering chamber (502) and providing a continues powder-form metal scrap (H) supply to the additive manufacturing device (9). Metal scraps (H) from the sieve (15) are first transferred to the first gathering chamber (501). There is a first gathering chamber inlet valve (1010) provided on the first gathering chamber (501), enabling metal scrap (H) to be transferred to the first gathering chamber (501) and controlled by the control unit to assume an open or a closed position. There is a second gathering chamber inlet valve (1011) provided on the second gathering chamber (502), enabling metal scrap (H) to be transferred to the second gathering chamber (502) and controlled by the control unit (7). When the first gathering chamber (501) is almost completely filled, filling data is transferred from the sensors on the transmission line to the control unit. As a result of this, the first gathering chamber inlet valve (1010) is closed by the control unit and simultaneously the second gathering chamber inlet valve (1011), which is in a closed position, is then opened and the metal scraps (H) transferred from the sieve (15) are transferred to the second gathering chamber (502) through the control unit transmission line (3). In this way, metal scraps (H) will be transferred to the additive manufacturing device (9) in a continuous manner.

In an embodiment of the invention, the metal powder recycling system (1) comprises a first vacuum unit (1101) into which metal scraps (H) are transferred from the first chamber (201) through the transmission line (3); a first hydration chamber (1201) into which metal scraps (H) are transferred from the first vacuum unit (1101) through the transmission line (3); a second vacuum unit (1102) into which metal scraps (H) are transferred from the second chamber (202) through the transmission line (3); a second hydration chamber (1202) into which metal scraps (H) are transferred from the second vacuum unit (1102); a first sensor (601) positioned on the first vacuum unit (1101) and second vacuum unit (1102) and gathering filling and failure data; a second sensor (602) positioned on the first hydration chamber (1201) and second hydration chamber (1202) and gathering filling and failure data; and a control unit (7) controlling the transferring of metal scraps (H) from the scrap chamber (16) to the first chamber (201) or second chamber (202) according to the filling or failure data transmitted from the sensors (6) and thus providing a continuous scrap transfer to the gathering chamber (5). After the first chamber (201) is almost completely filled, the first chamber inlet valve (1006) is closed and the first chamber outlet valve (1007) is opened by the control unit (7). In this way, metal scraps (H) collected in the first chamber (201) are transferred to the first vacuum unit (1101). After the first vacuum unit (1101) is almost completely filled, the metal scraps (H) are subjected to an oxygen removal process in the first vacuum unit (1101) and the deoxygenated metal scraps (H) are transferred to the first hydration chamber (1201) through the transmission line (3). After the first chamber inlet valve (1006) is closed, the metal scraps (H) transferred from the scrap chamber (16) are transferred to the second chamber (202) through the second chamber inlet valve (1008) opened by the control unit (7). After the second chamber (202) is almost completely filled, metal scraps (H) are transferred to the second vacuum unit (1102) to be subjected to an oxygen removal process. After the completion of the oxygen removal process in the second vacuum unit (1102), metal scraps (H) are transferred to the second hydration chamber (1202) through the transmission line (3). A first sensor (601), which enables the detection of the operating conditions, filling rates and failure states of the vacuum units (11) is provided on the first vacuum unit (1101) and second vacuum unit (1102); and a second sensor (602), which enables the detection of operating conditions, filling rates and failure states is provided on the first hydration chamber (1201) and second hydration chamber (1202). Based on the data transmitted from the first sensor (601) and the second sensor (602) to the control unit (7), the control unit (7) provides the control of the first chamber inlet valve (1006) and second chamber inlet valve (1008) to transfer the metal scraps (H) from the scrap chamber (16) to the first chamber (201) or the second chamber (202). In this way, it is enabled to continuously provide metal scraps (H) in the transmission line (3) between the pretreatment unit (4) and the gathering chamber (5).

In an embodiment of the invention, the metal powder recycling system (1) comprises a mill (14) consisting of at least two mutually disposed grinders (17), each of which being of a different size and each rotating about its axis in a direction opposite to the other's direction of rotation. Converting metal scraps (2) into powder form in the mill (14) is carried out by means of the grinders (17) that rotate in opposite directions with respect to each other. The grinders (17) positioned at a level that is higher than the others' enable the metal scraps (2) to be broken in larger sizes and the grinders (17) positioned at a level that is lower than the others' enable the metal scraps (2) to be broken in smaller sizes to obtain the powder form. In this way, the dimensions of the metal scrap (2) obtained by changing the dimensions of the grinder (17) can be changed.

In an embodiment of the invention, the metal powder recycling system (1) comprises at least one residue chamber (18), which enables to collect the metal scraps (H) which are out of user-predetermined sizes before being sent to the mill (14) to be reground, and into which metal scraps (H) are transferred from the sieve (15) through the transmission line (3).

After vibration is applied to the sieve (12), the metal scraps (2) that cannot pass through the pores with dimensions predetermined by the user are first transferred to the residue chamber by means of a platform (4). The mill (11) is then moved into the system by means of the platform (4) for regrinding purposes.

In an embodiment of the invention, the metal powder recycling system (1) comprises a cooling chamber (13) having an outer surface over which a cooling fluid is passed from the first outlet port (19) that is in connection with the mill (14) to the second outlet port (20) that is in connection with the hydration chambers (15), thereby preventing the formation of agglomeration. It is enabled to cool down the metal scraps (2) contained in the cooling chamber (13) by passing the cooling fluid from the outer wall of the cooling chamber from bottom to top.

In an embodiment of the invention, the metal powder recycling system (1) comprises a sieve (15) having a vibration band thereon, thereby enabling the separation of metal scraps (H) of a user-predetermined size. Metal scraps (2) leaving the mill (14) are collected on the sieve (12) where they are subjected to continuous vibration. Powder-form metal scraps (H) smaller than the pore size predetermined by the user will be transferred to the gathering chamber (5) thanks to the vibration applied.

In an embodiment of the invention, the metal powder recycling system (1) comprises at least one motor (21) triggered by a signal transmitted by the control unit (7), and a transmission line (3) triggered by the motor (21). Moving the platform (4) with the help of the motor (21) allows controlling the speed of the platform (4) in the metal powder recycling system (1), so that in case of a slowdown or acceleration during the recycling process, the amount of metal scrap (H) fed can be adjusted with the speed of the platform (4), and the amount of scrap that can be recycled can be maximized.

In an embodiment of the invention, the metal powder recycling system (1) comprises a vacuum unit (11) which is rotatable about its axis or rotatable from its non-symmetrical axis, thereby providing a more efficient vacuum. The vacuum unit (11) with a movable design will eliminate the problem of preventing the penetration of gas with the metal scraps (2) overlapping. The vacuum unit (11) will rotate around its axis to enable the continuous movement of metal scraps (2) with a centripetal force, or the vacuum unit (11) will rotate from a point other than its axis of symmetry and create a shaking motion, thereby allowing the gas to penetrate into the metal scraps (H) more efficiently.

In an embodiment of the invention, the metal powder recycling system (1) comprises metal scraps (H) produced from titanium alloy.

1. A metal powder recycling system (1) comprising: at least one chamber (2) into which metal scraps (H) are placed, at least one transmission line (3) enabling metal scraps (H) to be transferred out of the chamber (2), at least one pretreatment unit (4) into which the metal scraps (H) are transferred through the transmission line (3) and in which is configured to perform oxygen-removal, hydrogenation, cooling, grinding and sieving processes for the metal scraps (H), at least one gathering chamber (5) into which the sieved powder-form metal scraps (H) are transferred from the pretreatment unit (4) through the transmission line (3), characterized by at least one dehydrogenation chamber (8) into which powder-form metal scraps (H) are transferred from the gathering chamber (5) to perform a dehydrogenation process therein; at last one additive manufacturing device (9) into which the powder-form metal scrapes (H) dehydrogenated for use in production are transferred through the transmission line (3); multiple transmission lines (3) between the chamber (2) and the additive manufacturing device (9); at least one sensor (6) provided on the transmission line (3); at least one control unit (7) configured to control the supply of metal scraps (H) in transmission lines (3) according to the data transmitted from the sensors (6); and multiple valves (10) controlled by the control unit (7) according to the data the control unit (7) receives from the sensors (6) so as to assume an open or closed position, thereby allowing a simultaneous and continuous presence of metal scraps (H) in the transmission line (3) in which metal scraps (H) are transferred out of the chamber (2) and in the transmission line (3) that transferring metal scraps (H) to the additive manufacturing device (9), after the first metal scraps (H) are transmitted to the additive manufacturing device (9).

2-3. (canceled)

4. The metal powder recycling system (1) as claimed in claim 1, comprising at least one vacuum unit (11) provided in the pretreatment unit (4) and enabling the removal of oxygen present in the structure of metal scraps (H) transferred therein from the chamber (2) through the transmission line (3); at least one vacuum unit outlet valve (1001) opened by the control unit (7) according to the data transmitted by the sensors (6) after the completion of the oxygen removal process in the vacuum unit (11) and enabling the metal scraps (H) to be transferred to the transmission line (3); at least one hydrogenation chamber (12) into which metal scraps (H) are transferred from the vacuum unit (11) and a hydrogenation process is applied to the metal scraps (H); at least one hydrogenation chamber outlet valve (1002) opened by the control unit (7) according to the data transmitted from the sensors (6) after the completion of the hydrogenation process and enabling the metal scraps (H) to be transferred to the transmission line (3); at least one cooling chamber (13) enabling the cooling of the metal scraps (H) transferred therein from the hydrogenation chamber (12); at least one cooling chamber outlet valve (1003) opened by the control unit (7) according to the data transmitted from the sensors (6) after the completion of the cooling process and enabling the metal scraps (H) to be transferred to the transmission line (3); at least one mill (14) enabling the metal scraps (H) transferred therein from the cooling chamber (13) to be brought to user-predetermined sizes; at least one mill outlet valve (1004) opened by the control unit (7) according to the data transmitted from the sensors (6) after the completion of the grinding process and enabling the metal scraps (H) to be transferred to the transmission line (3); at least one sieve (15) enabling the metal scraps (H) to be sieved to different sizes, said metal scraps (H) being transferred therein from the mill (14); and at least one sieve outlet valve (1005) opened by the control unit (7) according to the data transmitted from the sensors (6) after the completion of the sieving process and enabling the powder-form metal scraps (H) to be transferred to the transmission line (3).

5. The metal powder recycling system (1) as claimed in claim 1, comprising at least one scrap chamber (16) in which metal scraps (H) are collected; a first chamber (201) and/or a second chamber (202) into which metal scrap (H) is transferred from the scrap chamber (16) through the transmission line (3); a first chamber inlet valve (1006) and a first chamber outlet valve (1007) provided in the first chamber (201); a second chamber inlet valve (1008) and a second chamber outlet valve (1009) provided in the second chamber (202); said control unit (7) closing the first chamber inlet valve (1006) according to the data it receives from the sensors (6) when the first chamber (201) is almost completely filled, and simultaneously opening the second chamber inlet valve (1008) and the first chamber outlet valve (1007) and thus enabling the pretreatment unit (4) to be filled continuously with metal scraps (H) so that it is never left empty.

6. The metal powder recycling system (1) as claimed in claim 1, comprising a first gathering chamber (501) and a second gathering chamber (502) in which sieved metal scraps (H) are collected; a first gathering chamber inlet valve (1010) provided in the first gathering chamber (501) and controlled by the control unit (7); a second gathering chamber inlet valve (1011) provided in the second gathering chamber (502) and controlled by the control unit (7); said control unit (7) closing the first gathering chamber inlet valve (1010) according to the data transmitted by the sensors (6) when the first gathering chamber (501) is almost completely filled and opening the second gathering chamber inlet valve (1011), thus enabling the powder-form metal scraps (H) to be transferred to the second gathering chamber (502) and providing a continues powder-form metal scrap (H) supply to the additive manufacturing device (9).

7. The metal powder recycling system (1) as claimed in claim 5, comprising a first vacuum unit (1101) into which metal scraps (H) are transferred from the first chamber (201) through the transmission line (3); a first hydration chamber (1201) into which metal scraps (H) are transferred from the first vacuum unit (1101) through the transmission line (3); a second vacuum unit (1102) into which metal scraps (H) are transferred from the second chamber (202) through the transmission line (3); a second hydrogenation chamber (1202) into which metal scraps (H) are transferred from the second vacuum unit (1102); a first sensor (601) positioned on the first vacuum unit (1101) and second vacuum unit (1102) and gathering filling and failure data; a second sensor (602) positioned on the first hydrogenation chamber (1201) and second hydrogenation chamber (1202) and gathering filling and failure data; said control unit (7) controlling the transferring of metal scraps (H) from the scrap chamber (16) to the first chamber (201) or second chamber (202) according to the filling or failure data transmitted from the sensors (6) and thus providing a continuous scrap transfer to the gathering chamber (5).

8. The metal powder recycling system (1) as claimed in claim 4, wherein the mill (14) is composed of at least two mutually disposed grinders (17), each of which being of a different size and each rotating about its axis in a direction opposite to the other's direction of rotation.

9. The metal powder recycling system (1) as claimed in claim 4, comprising at least one residue chamber (18) which enables to collect the metal scraps (H), which are out of user-predetermined sizes before being sent to the mill (14) to be reground, and into which metal scraps (H) are transferred from the sieve (15) through the transmission line (3).

10. The metal powder recycling system (1) as claimed in claim 4, wherein the cooling chamber (13) has an outer surface over which a cooling fluid is passed from the first outlet port (19) that is in connection with the mill (14) to the second outlet port (20) that is in connection with the hydration chambers (15), thereby preventing the formation of agglomeration.

11. The metal powder recycling system (1) as claimed in claim 4, wherein the sieve (15) has a vibration band thereon, thereby enabling the separation of metal scraps (H) of a user-predetermined size.

12. The metal powder recycling system (1) as claimed in claim 1, comprising at least one motor (21) triggered by a signal transmitted by the control unit (7), the transmission line (3) being triggered by the motor (21).

13. The metal powder recycling system (1) as claimed in claim 4, wherein the vacuum unit (11) is rotatable about its axis or rotatable from its non-symmetrical axis, thereby providing a more efficient vacuum.

14. The metal powder recycling system (1) as claimed in claim 1, wherein the metal scraps (H) are produced from titanium alloy.
